(19) United States
(12) Patent Application Publication
(10) Pub. No.: US 2016/0012433 A1
(43) Pub. Date: Jan. 14, 2016

(54) SYSTEMS AND METHODS FOR SENDING PAYMENT DATA USING A MOBILE ELECTRONIC DEVICE TO TRANSACT WITH OTHER COMPUTING DEVICES

(71) Applicant: PAYDUNK, LLC, Pine Brook, NJ (US)

(72) Inventor: Michael Marenick, Glen Ridge, NJ (US)

(21) Appl. No.: 14/795,573

(22) Filed: Jul. 9, 2015

Related U.S. Application Data
(60) Provisional application No. 62/022,464, filed on Jul. 9, 2014.

(51) Int. Cl. G06Q 20/38; G06Q 20/40; G06Q 20/32

(52) U.S. Cl. CPC G06Q 20/3823; G06Q 20/322; G06Q 20/4012; G06Q 20/409; G06Q 20/4014

(57) ABSTRACT

An online payment service is configured for a computing device to receive payment information from a central mobile device via wireless connection. Using an application on the central mobile device, a user's payment information, billing information, shipping information, and loyalty card information can be configured and stored on the mobile device. Online services can install a payment link for the user to select for payment. When the payment link is activated on the mobile device, it triggers the central mobile device to restore the state of the application. The payment link identifies the central mobile device by a unique mobile number. Upon confirmation, the application transfers in encrypted format the payment, billing, shipping, and loyalty card information to the computing device that made the request. The computing device then uses the information to process the payment on its own platform. A confirmation of a payment approval or decline is transmitted to the device that initiated the transaction.

### CROSS-REFERENCE TO RELATED APPLICATIONS

This application claims priority to U.S. Provisional Patent Application Ser. No. 62/022,464, filed Jul. 9, 2014, which is hereby incorporated by reference in its entirety.

### TECHNICAL FIELD

This invention relates generally to a computer system configured for mobile device transactions.

### BACKGROUND

Each year, consumers are accessing the internet more via a mobile device. In 2015, more consumers will access the internet via a mobile device than a desktop computer. Retail purchasing on mobile devices has not improved at the same rate, because the checkout process still suffers from drawbacks, thereby limiting the purchases made by mobile device.

One conventional solution for mobile device checkout is an application (“app”) or mobile site that requires a significant amount of input via a touch screen. An improvement to this conventional solution is the use of an online payments system, such as PayPal Checkout. However, such approaches may require the retailer to have two separate merchant accounts.

For example, a conventional checkout process proceeds as follows. First, a user manually inputs payment details for each transaction via a desktop keyboard, QWERTY keyboard, or touch screen keyboard. Second, the user creates an account on a website that stores their payment information for later use online. Third, the user creates an account with an online central payment service that stores their payment information for online use. Fourth, users use a biometric identification mechanism to unlock and release payment information from a stored online account. Fifth, the user calls a phone number and interacts with a live operator to complete the purchase. Alternatively, the user opens a chat window and interacts with a live operator to complete the purchase.

Websites have shopping carts that collect payment information and billing information and that information is transmitted to a merchant processor. However, shopping carts for website were never standardized. As a result, the order of the information in the shopping cart may not directly correspond to the order of the information to be processed by the merchant processor, thereby causing inefficiency in the process. In an attempt to resolve this issue, many merchant processors created their own gateway.

Some conventional payment processes require a user to input information using a keyboard on a mobile phone, which can cause many errors, adds to the complexity of the process, and can delay the process as the user needs to obtain and enter information. Passwords commonly require at least one capital letter, at least one alphabetic character, and at least one numeric character, thereby adding to the complexity of what must be remembered by the user and what must be entered on the keyboard. Such issues can dissuade a user from conducting an online or mobile transaction. A conventional process may proceed as follows. First, a user selects a payment button on a website, which directs the user through various steps using an online payment or checkout flow. The user interacts with the user interface using an alphanumeric input device, such as a keyboard. Second, the user logs into an account that was created specifically for the online website, where the account already has the payment information stored. The login typically requires a username (or email address) and password. This login typically requires use of an alphanumeric input device, such as a QWERTY keyboard. Third, the user selects a payment services button for a service that stores their payment information online. To complete the payment, the user logs into an account using a username (or email address) and password. This login typically requires use of an alphanumeric input device, such as a QWERTY keyboard.

When a user wants to purchase an item that is seen during television programming, the user has limited options for purchasing that item. In one option, the user can turn to a different device and purchase that item on a website. In another option, the user can call a phone number and interact with a live operator or automated payment queue to complete the purchase. In yet another option, the user can complete a transaction using a remote control, but payments are billed to the user by the television service (or internet service or cable service) provider. There are no efficient systems for allowing a user to make a purchase of an item on a television using a payment account chosen by the user.

The Payment Card Industry Data Security Standard (PCI DSS) is a set of requirements designed to ensure that all companies that process, store, or transmit cardholder information (e.g., cardholder name, expiration date, service code, magnetic stripe data, CAV2, CVC2, CVV2, CID, PINS, PIN blocks) maintain a secure environment. Even companies using a third party processor must be PCI compliant. PCI compliance involves debit cards, credit cards, and pre-paid cards for American Express, Discover, JCB, MasterCard, and Visa. SSL certificates do not secure a web server from malicious attacks or intrusions, so reliance upon SSL is not sufficient for PCI compliance.

It is desired to have an online payments service that allows a mobile device to conduct a transaction in a more efficient and more secure manner.

### SUMMARY

The systems and methods described herein attempt to cure the deficiencies of the conventional arts by configuring a computer system to allow for transactions over the internet via a mobile device in a more efficient and secure manner. The systems and methods offer benefits to consumers, such as a fast, simple touchscreen checkout; no typing of complex alphanumeric passwords is required on a small touch screen keyboard; credit card information is not stored on a retailer computer; and a safe, secure payment solution. The systems and methods offer benefits to merchants, such as an integration to an existing site; no need to change or add a merchant account; increased mobile sales opportunities; and faster customer checkout. Credit card and personal information is encrypted and stored securely on a mobile device (e.g., mobile phone) and is not required to be stored and transmitted amongst the various devices required in a conventional transaction.

In one embodiment, a system comprises a data store containing data, for each of a plurality of mobile devices, each mobile device having an association with phone number data, personal identification number data, billing address data, payment card number data, and expiration date data; and a secure transaction server communicatively coupled to the data store and programmed to: receive from a merchant server over a network a signal including activation of a link displayed on an electronic web page hosted by the merchant server; receive over the network a signal including phone number data and personal identification number data from the electronic web page; transmit a message requesting confirmation of a transaction to a phone number of a mobile device in the received phone number data when a personal identification number in the received personal identification number data is authenticated upon a comparison with the data in the data store, wherein the message comprises transaction information, and whereby the message causes a restoration of an application on the mobile device; receive from the application on the mobile device associated with the phone number an encrypted packet comprising the transaction information and payment information upon a receipt of an authorization command by the application for the transaction; and transmit the encrypted packet to a payment gateway server, whereby the payment gateway server decrypts the packet and transmits the transaction information and payment information to a merchant processor, and wherein the merchant server does not receive payment card number data for the transaction.

In another embodiment, a computer-implemented method comprises receiving, by a secure transaction server, from a merchant server over a network a signal including activation of a link displayed on an electronic web page hosted by the merchant server; receiving, by the secure transaction server, over the network a signal including phone number data and personal identification number data from the electronic web page; transmitting, by the secure transaction server, a message requesting confirmation of a transaction to a phone number of a mobile device in the received phone number data when a personal identification number in the received personal identification number data is authenticated upon a comparison with the data in the data store, wherein the message comprises transaction information, and whereby the message causes a restoration of an application on the mobile device; receiving, by the secure transaction server, from the application on the mobile device associated with the phone number an encrypted packet comprising the transaction information and payment information upon a receipt of an authorization command by the application for the transaction; and transmitting, by the secure transaction server, the encrypted packet to a payment gateway server, whereby the payment gateway server decrypts the packet and transmits the transaction information and payment information to a merchant processor, and wherein the merchant server does not receive payment card number data for the transaction.

In yet another embodiment, a computer-implemented method comprises receiving, by a secure transaction server, a phone number and a personal identification number entered on a modal of a webpage hosted by a merchant server; confirming, by the secure transaction server, a user using the received phone number and personal identification number; generate, by the secure transaction server, transaction information for display on an application of a mobile device; causing, by the secure transaction server, a restoration of the application of the mobile device to display the transaction information; receiving, by the secure transaction server, a packet of encrypted information generated by the application and comprising the transaction information and payment information; and transmitting, by the secure transaction server, the packet of encrypted information to a payment gateway server that is configured to decrypt the encrypted information and transmit the decrypted information to a merchant processor for processing, wherein the merchant server does not receive the payment information.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 shows a system overview according to an exemplary embodiment.

FIG. 2 shows user interfaces on a mobile device according to an exemplary embodiment.

FIG. 3 shows a process according to an exemplary embodiment.

FIG. 4 shows user interfaces on a mobile device according to an exemplary embodiment.

FIG. 5 shows user interfaces on a mobile device according to an exemplary embodiment.

FIG. 6 shows user interfaces on a mobile device according to an exemplary embodiment.

FIG. 7 shows user interfaces on a mobile device according to an exemplary embodiment.

FIG. 8 shows user interfaces on a mobile device according to an exemplary embodiment.

FIG. 9 shows user interfaces on a mobile device according to an exemplary embodiment.

FIG. 10 shows user interfaces on a mobile device according to an exemplary embodiment.

FIG. 11 shows user interfaces on a mobile device according to an exemplary embodiment.

FIG. 12 shows user interfaces on a mobile device according to an exemplary embodiment.

FIG. 13 shows user interfaces on a mobile device according to an exemplary embodiment.

FIG. 14 shows user interfaces on a mobile device according to an exemplary embodiment.

FIG. 15 shows user interfaces on a mobile device according to an exemplary embodiment.

FIG. 16 shows a web page interface on a web browser according to an exemplary embodiment.

FIG. 17 shows a web page interface on a web browser according to an exemplary embodiment.

FIG. 18 shows a process according to an exemplary embodiment.

FIG. 19 shows user interfaces on a mobile device according to an exemplary embodiment.

FIG. 20 shows a user interface on a mobile device according to an exemplary embodiment.

FIG. 21 shows user interfaces on a mobile device according to an exemplary embodiment.

FIG. 22 shows user interfaces on a mobile device according to an exemplary embodiment.

FIG. 23 shows a process according to an exemplary embodiment.

FIG. 24 shows a process according to an exemplary embodiment.

FIG. 25 shows user interfaces on a mobile device according to an exemplary embodiment.

FIG. 26 shows user interfaces on a mobile device according to an exemplary embodiment.

FIG. 27 shows a process according to an exemplary embodiment.

FIG. 28 shows a web page interface on a web browser according to an exemplary embodiment.

FIG. 29 shows a process according to an exemplary embodiment.

FIG. 30 shows a process according to an exemplary embodiment.

### DETAILED DESCRIPTION

Various embodiments and aspects of the invention will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present invention.

The systems and methods described herein configure an online payment service configured for a computing device (e.g., desktop computer, tablet computer, mobile device, television) to receive payment information from a central mobile device via wireless connection (e.g., Wi-Fi, cellular, satellite service). Using an application on the central mobile device, a user's payment information, billing information, shipping information, and loyalty card information can be configured and stored on the mobile device. Online services (e.g., retail sales, bill payments, peer-to-peer payments, or a transaction requiring exchange of funds online) can install a payment link on a web page or other electronic page (e.g., for a television or application) for the user to select for payment. When the payment link is activated on the mobile device, it triggers the central mobile device to restore the state of the application. The payment link identifies the central mobile device by a unique mobile number (or other identification). Upon confirmation, the application on the mobile device transfers in encrypted format the payment, billing, shipping, and loyalty card information to the computing device that made the request. The computing device then uses the information to process the payment on its own platform. A confirmation of a payment approval or decline is transmitted to the device that initiated the transaction.

As described herein, a specially-programmed secure transaction server and associated database are components of a reconfigured computer system. The reconfigured computer system may be referred to by its commercial name Paydunk (or “paydunk”). Any buttons, links, or user interfaces that use the Paydunk name are merely exemplary of how a button, link, or user interface may be configured, but are intended to reflect a specially-programmed feature of the computer system described herein. For example, the Paydunk button on a user interface on a mobile device may operate with a different label or name but is intended to represent the functionality described herein with respect to that button.

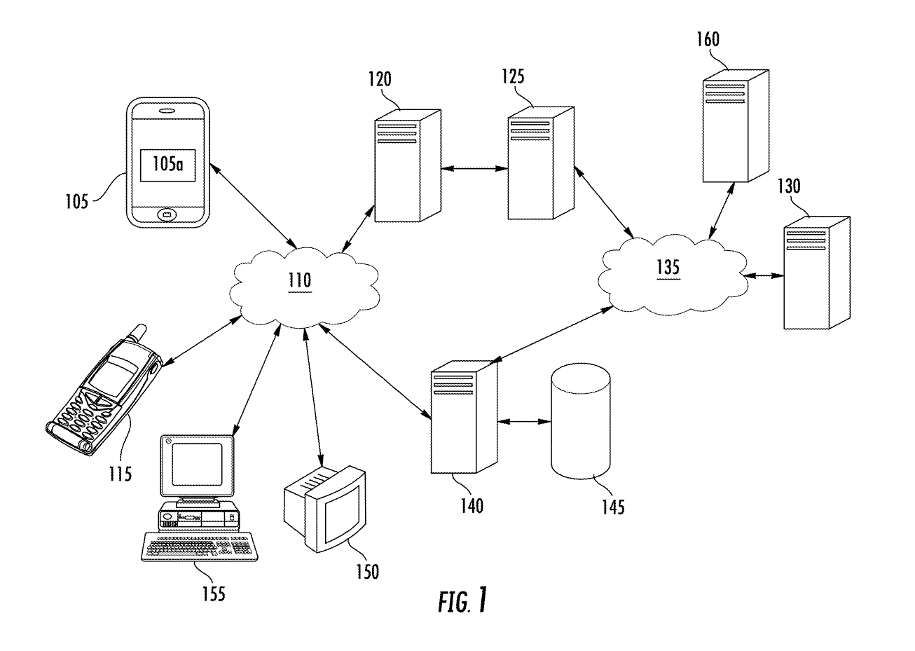

Referring to FIG. 1, an exemplary system architecture is shown. A user has a mobile device 105, such as a smart phone, cellular phone, mobile phone, personal data assistant, tablet computer, smart watch, or the like. The mobile device 105 has a processor, a data store, and is configured to communicate over a network, such as the internet 110. The data store can store information such as payment information for a user, including a payment card account number, expiration date, CVV code, and the like. Access to the internet 110 may be via a cellular connection, Wi-Fi connection, satellite connection, or the like. The mobile device 105 also has an input device, such as a touch screen, keypad, keyboard, stylus, mouse, or the like.

The mobile device 105 may be referred to a single central mobile device. It is intended that numerous users can use numerous mobile devices. A user may have more than one mobile device, and multiple users may share a mobile device. However, each mobile device can be configured to provide a single authorization mechanism for a user. When a user conducts a transaction using one of a plurality of different mechanisms, the mobile device is used for authentication and processing the payment information. The term “single” is not intended to limit the mobile device to a single device in the system. The term “central” is not intended to limit the mobile device to a configuration of the system where all communication must go through the mobile device.

The mobile device has an application 105a that is stored in the data store on the mobile device 105 and executed by the processor of the mobile device 105. Data for the application 105a can also be stored in the data store of the mobile device 105a. The application 105a can be running on the mobile device 105, and upon activation of a link or other trigger, the application 105a can be restored and presented on the display of the mobile device 105 for interaction with a user. When the application 105a is not being used and/or has not been triggered, it can run on the mobile device until restoration on the display. From the user's perspective, the application 105a will be “sleeping” or “running in the background” and then awoken once triggered. The application 105a is configured to receive transaction information (e.g., transaction amount, items purchased), authorize a payment for the transaction, generate an encrypted packet of transaction information and payment information (e.g., payment card account number, expiration date, CVV code) upon authorizing the payment, and transmit the encrypted packet to an application program interface of a secure transaction server 140.

A computing device, such as a television, a personal computer, a mobile phone, or a point of sale terminal, can be used to initiate a transaction. A television or other programming-viewing device 150, such as a smart television, can be communicatively coupled to the network 110. For example, the television may present programming (e.g., pay-per-view programs) for purchase by a user. In another example, the television may present a commercial or infomercial with an item for purchase by a user. In another example, the television may display a web browser for accessing web pages on the internet.

A user computing device 155, such as a desktop computer, laptop computer, tablet computer, workstation computer, gaming console, kiosk, eReader, smart watch, wearable device, in-car browser based system, in-airplane browser based system, or the like, can be communicatively coupled to the network 110. For example, the user computing device may present an application for purchase by a user. In another example, the user computing device may present an application with a feature or media for purchase by a user. In another example, the user computing device may display a web browser for accessing web pages on the internet.

A point of sale terminal 115 is configured to communicate over the network 110. The point of sale terminal can be a device at a store or a portable point of sale device. The point of sale terminal 115 can include a processor to execute software on the point of sale terminal 115 to transmit instructions and data over the network 110 and receive instructions and data over the network 110. The point of sale terminal 115 can have a card reader that reads payment card upon swiping the magnetic stripe of the payment cards, an EMV card reader that reads a chip of the payment card, other card reader that reads a chip of a smart card, an RFID reader, or other contact or contactless payment mechanism. The point of sale terminal 115 can be communicatively coupled to a merchant web server 120.

The merchant web server 120 is configured to present web pages of a merchant for rendering on a browser of a user's computing device, such as the mobile device 105, television 150, or computer 155. The merchant web server 120 is configured to transmit instructions and data over the network 110 for display on a browser or application and receive instructions and data over the network 110 from the browser or application. The merchant web server 120 can be configured to present a link to be displayed on a web page that upon activation will direct the user on the computing device to a secure transaction server 140 for authentication.

The merchant web server 120 is communicatively coupled to a merchant payment server 125. The merchant payment server 125 is configured to receive information from the web server 120 that was transmitted by a user via a computing device (e.g., mobile device 105) or point of sale terminal 115 or other network-connected device. The merchant payment server 125 can also send product information, payment information, and confirmation messages to the mobile device 105, point of sale terminal 115, or other network-connected device via merchant web server 120 and through network 110. The merchant payment server 125 can have an integrated data store or be communicatively coupled to a data store (not shown) for storing data regarding payments, users, products, and services.

The merchant payment server 125 can be communicatively coupled to a payment gateway server 130 over a network 135. The network 135 may be the same network as network 110, or network 135 may be a private network, direct connection network, web-based connection, or privately held leased lines. The payment gateway server 130 is communicatively coupled to a merchant processor 160 over the network 135. The payment gateway server 130 receives encrypted packets of transaction information from the mobile device 105 via the secure transaction server 140. The payment gateway server 130 decrypts the packets of transaction information and provides the transaction information to the merchant processor 160, which processes the transaction. As a result, the merchant's web server 120 and the merchant's application server 125 do not receive the user's payment card account information. The merchant processor 160 can send a confirmation message to the merchant's application server 125 that the payment information has been successfully processed for the pending transaction.

The secure transaction server 140 is also communicatively coupled through the network 110 to the other network-connected devices (e.g., mobile device 105). The secure transaction server 140 has an application program interface (API) for interfacing with the application 105a on the mobile device 105. The secure transaction server 140 is communicatively coupled to a data store 145, which can store phone numbers, personal identification numbers, user name and address information, and push notification tokens.

The secure transaction server 140 can transmit information through the network 135 directly to the payment gateway server 130. This flow of the user's sensitive information allows for a completely enclosed PCI-compliant ecommerce payment system. When the secure transaction server 140 transmits the payment information from the mobile device 105 to the payment gateway server 130, the payment information is never laid “at rest,” so it is less vulnerable to hackers. In conventional payment solutions, information entered on a user's keyboard is still vulnerable to being stolen until it reaches a payment gateway server. Even using keystroke fillers, such as “1password,” can leave the user's information vulnerable in conventional payment solutions. When a user makes a payment online using the system described herein, the merchant web server 120 and the merchant payment server 125 never access or can view the payment information. So if the merchant is hacked, the hacker cannot obtain the user's payment information. Instead, the user's payment information passes directly in an encrypted form from the mobile device through the network 110 to the secure transaction server 140 and to the payment gateway server 130. The payment gateway server 130 is configured to decrypt the encrypted payment information that it receives.

The single central mobile device 105 allows a user to complete the payment transaction with a television, cable, or satellite service via Wi-Fi, cellular, or satellite communication. For example, the mobile device 105 (e.g., mobile phone) can communicate with the secure transaction server 140 for a transaction initiated with a television 150 (e.g., smart television or a television with set top box). As a user watches programming on the television 150, a link can appear on the user interface on the television screen that allows for selection and activation by the user. The user can use a remote control, touch screen, or mobile device to activate the link, which indicates that the user is interested in conducting a transaction (e.g., buying a product shown on the screen at the time). The activation of the link is transmitted in a message to a merchant web server 120, which can transmit a message to the secure transaction server 140 that the user is to be authenticated by the secure transaction server 140. The secure transaction server 140 can send a push notification to the mobile device 105 or otherwise instruct the mobile device 105 to restore the application 105a running on the mobile device 105. From the perspective of the user, upon activating the link on the television 150, the application 105a on the mobile device 105 is restored. Alternatively, the application 105a recognizes when the user is watching particular programming and what is presented on the screen, and a beacon or trigger can restore the application on the user interface of the mobile device 105. The user can select to authorize or decline the transaction from the application 105a. Optionally, the user can input a PIN (e.g., 4 digit PIN) in the application 105a as a requirement for authorizing payment. Once receiving the user's authorization, the application 105a compiles payment information stored on the mobile device 105 with the transaction information and generates an encrypted packet, which is transmitted to the secure transaction server 140. The secure transaction server 140 does not decrypt or otherwise process the packet, but rather passes it along to the payment gateway server 130. The payment gateway server 130 decrypts the packet and sends the decrypted information to the merchant processor 160 for processing.

When a user initiates a transaction, the user can use the mobile device 105 to authorize the payment. If the mobile device 105 has a touchscreen, then the user can be presented with a larger touch screen numeric keypad rather than the QWERTY keyboard conventionally required to enter payment and billing information. This larger touch screen keypad reduces errors and allows the system to more efficiently and more quickly process each transaction. In one embodiment, the touch screen requires only input of numeric digits on the keypad. The touch screen keypad has fewer keys than a conventional QWERTY keyboard and may take the configuration of a numeric keypad, which may resemble a virtualized version of a point of sale PIN pad. Because a phone number can be used instead of a username or email address, the user interface can be configured to allow only numeric inputs. While conventional usernames and passwords may require alphanumeric characters for increased security, the user interface here can utilize a numerical keypad of 0-9 because the sensitive information is stored locally and is encrypted, and it is not accessible to a third party, even if the third party can hack the mobile device. In the exemplary embodiment, the sensitive information is stored on the mobile device and associated with the application, but it is not stored on a chip, which cannot as easily allow browser-based checkout because the chip does not communicate with the browser.

The single central mobile device 105 allows a user to complete a payment transaction in a store without passing payment information to the merchant. The mobile device 105 can connect to the network 110 using a Wi-Fi (or Bluetooth or Infrared) connection and directly or indirectly communicate with a point of sale terminal 115. The point of sale terminal 115 can be configured with modules that process and communicate with the secure transaction server 140. For example, a user can proceed to a cashier to purchase an item at a store. The point of sale terminal 115 may present a few options for payment, such as “cash,” “credit,” “debit,” or “Paydunk,” where the Paydunk button represents the secure transaction system described herein.

Upon activating this link, the mobile device 105 is triggered to restore the application 105a so that the user can authorize payment on the mobile device 105. There are various implementations of this trigger. In one example, upon activation of this button, the point of sale terminal 115 will transmit a message to the secure transaction server 140 that a payment instruction was requested, and the secure transaction server 140 will trigger the application 105a on the mobile device 105 of the user to be restored to the user interface and present a keypad to the user. The user can enter a PIN (optionally) and select a payment method (e.g., which credit card, debit card, or other source account). The payment information and transaction information is then sent in an encrypted format through the secure transaction server 140 to the payment gateway server 130, and the merchant will receive a confirmation that the payment has been authorized but not the actual payment information. As a result, the user can complete a purchase without ever taking a physical payment card out of a wallet for payment.

In one alternative, when the user selects the Paydunk button, the Wi-Fi or Bluetooth connection can be used to locate the mobile device 105 by using a beacon. Once identifying the mobile device 105, the mobile device 105 can restore the application.

In another alternative, upon selecting the Paydunk button, the user can enter a phone number in the user interface of the point of sale terminal 115. The phone number can be used to associate the mobile device 105 with the point of sale terminal 115 and trigger the application 105a on the mobile device 105 to restore for use.

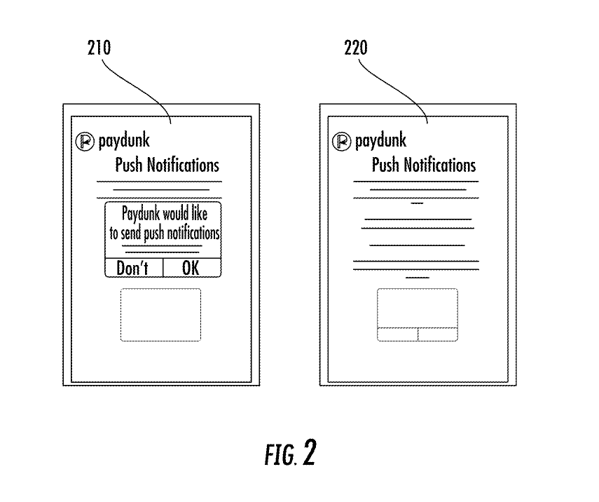

An exemplary process is as follows. A user chooses to make a purchase on the point of sale terminal 115, television 150, computing device 155, or mobile device 105 by activating a Paydunk button or link in a web browser or application. Upon activation of this button or link, the merchant payment server 125 transmits an API key and user identifying information to an API of the secure transaction server 140. The secure transaction server 140 transmits a push notification (e.g., using Amazon Simple Notification Service (SNS) or similar services that provides callbacks) to the mobile device 105 restoring the application 105a. Referring to FIG. 2, an exemplary user interface 210, 220 is shown where the mobile device presents to the user that push notifications are sent to the mobile device. The user enters a PIN or access code associated with the user's account on a user interface of the mobile device 105 to authorize the payment. After authorization, the mobile device 105 transmits an encrypted data payload to the secure transaction server 140. The secure transaction server 105 transmits the encrypted data payload to the payment gateway server 130, which decrypts the data payload and transmits it to the merchant processor 160 for payment processing. The merchant processor 160 transmits a message to the merchant payment server 125 that includes a confirmation of the authorization, user name, billing address, and shipping address. The secure transaction server 140 stores the encrypted user identification (e.g., phone number and PIN) and a push notification token in the data store 145.

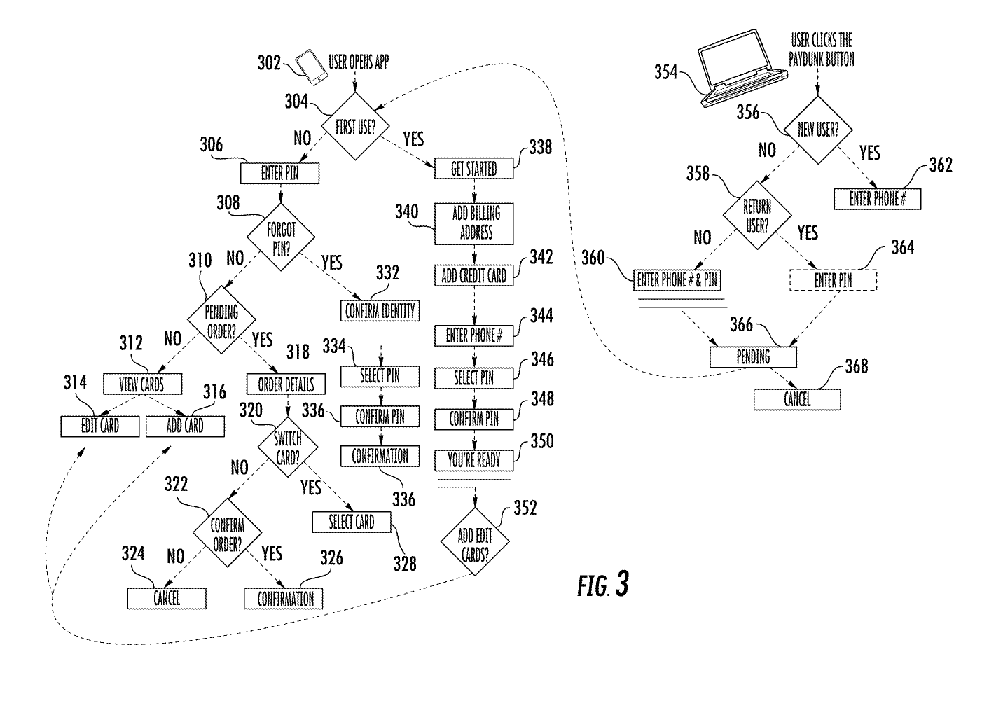

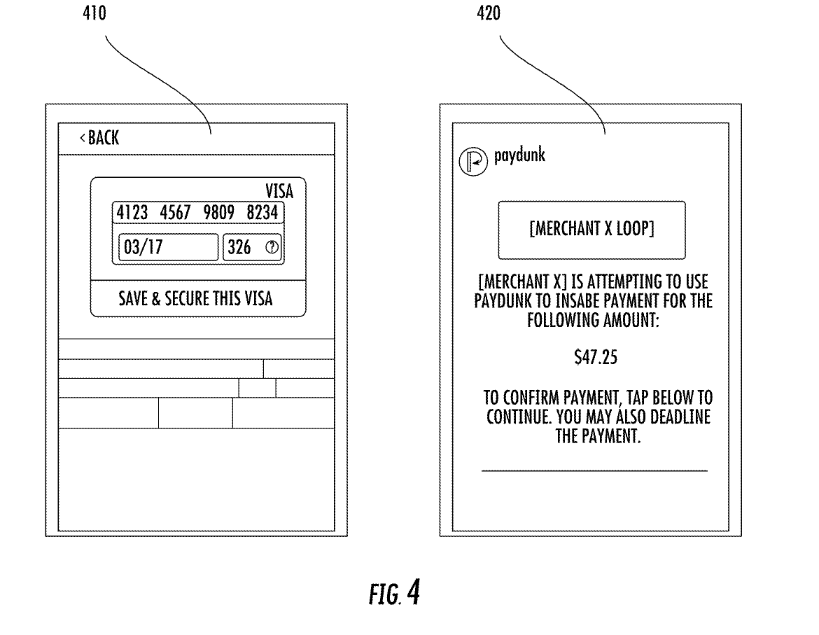

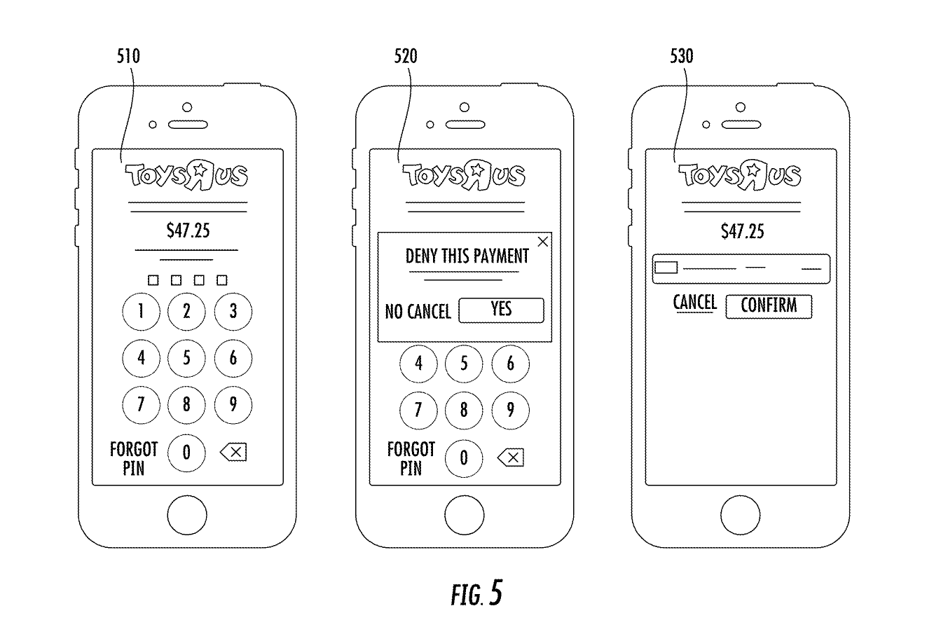

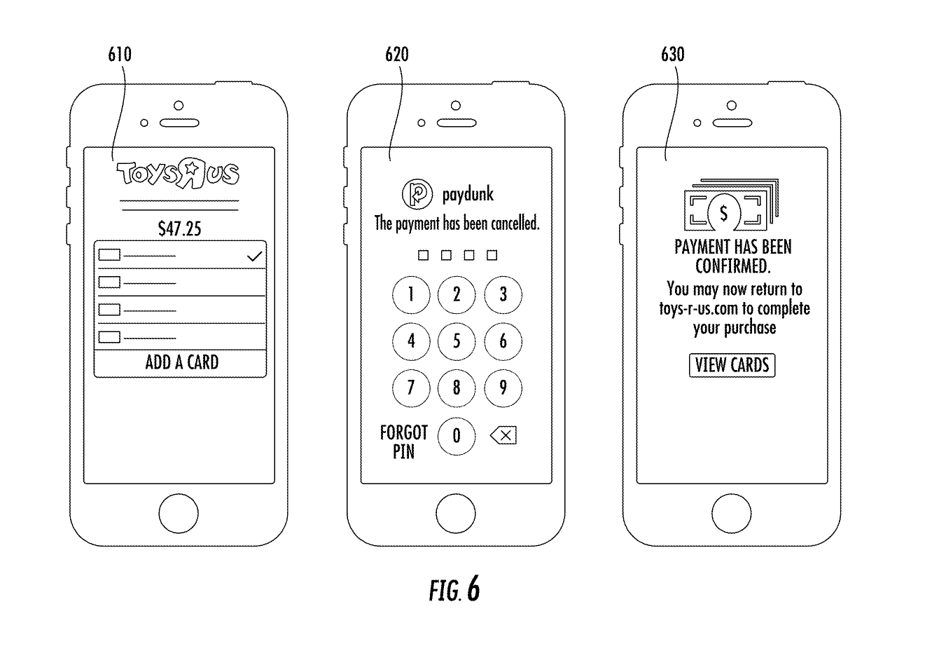

Referring to FIG. 3, an exemplary process is shown. In step 302, the mobile device presents the application to the user by restoring the application on the mobile device. In step 304, it is determined whether this is a first use of the application. In step 306, if it is not the first use, the user enters a PIN in the user interface. In step 308, it is determined whether the user forgot the PIN. In step 310, if the user did not forget the PIN, then it is determined whether there is a pending order. In step 312, if there is not a pending order, then the user interface on the mobile device displays the payment card accounts available for use by the user. In step 314, the user can edit a payment card account. In step 316, the user can add a payment card account. An exemplary user interface 410 for adding or editing a payment card account is shown in FIG. 4. In step 318, if there is a pending order, then the application displays the order details. An exemplary user interface 510 presents a request to authorize or confirm a pending payment request by entering a PIN, as shown in FIG. 5. In step 320, there is a determination of whether to switch payment card accounts. An exemplary user interface 610 presents a request to switch a payment card account for a pending payment, as shown in FIG. 6. In step 322, if payment card accounts are not switched, then the user can confirm the order. An exemplary user interface 530 presents a request to authorize or confirm a pending payment request, as shown in FIG. 5. If the user opted out of requiring a PIN code, this user interface will be presented. In step 324, if the order is not confirmed, then it is canceled. An exemplary user interface 520, 620 presents a request to deny a pending payment request, as shown in FIGS. 5 and 6. In step 326, if the order is confirmed, then there is a confirmation. An exemplary user interface 630 presents a confirmation of payment, as shown in FIG. 6. In step 328, if the payment card account is to be switched, then a different card is selected.

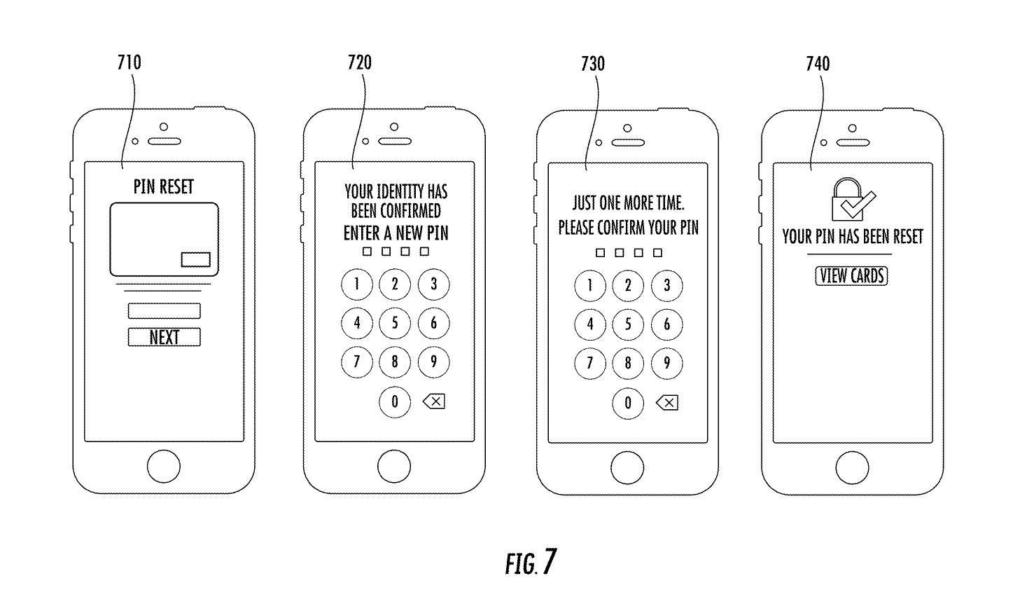

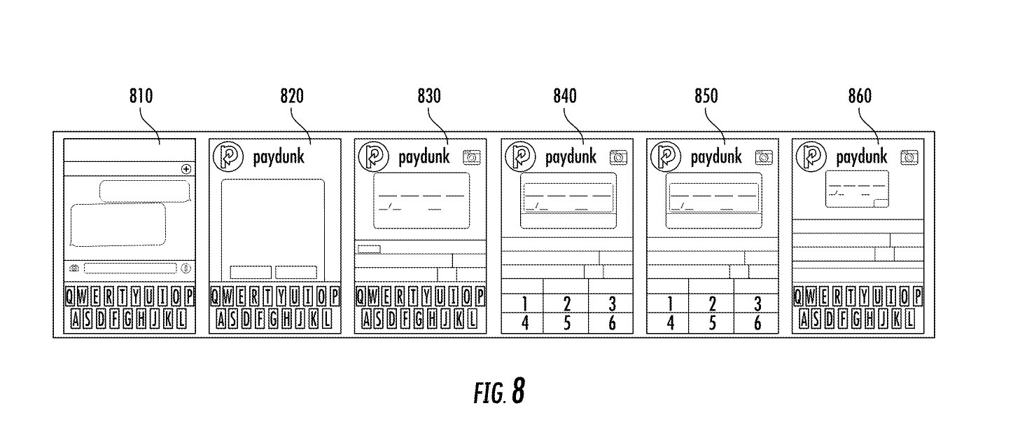

In step 330, if the user forgot the PIN, then the user is asked to confirm identity. In one embodiment, the application may ask to “Please enter the expiration date for the card ending in XXXX.” An exemplary user interface 710 for resetting a PIN by entering an expiration date is shown in FIG. 7. Alternatively, an exemplary user interface 810 for confirming a phone number via SMS message and receiving instructions to create a PIN is shown in FIG. 8. In step 332, the user can select a PIN. An exemplary user interface 720 for entering a new PIN is shown in FIG. 7. In step 334, the user can confirm the new PIN. An exemplary user interface 730 for confirming a new PIN is shown in FIG. 7. In step 336, there is a confirmation of the new PIN. An exemplary user interface 740 for entering a new PIN is shown in FIG. 7.

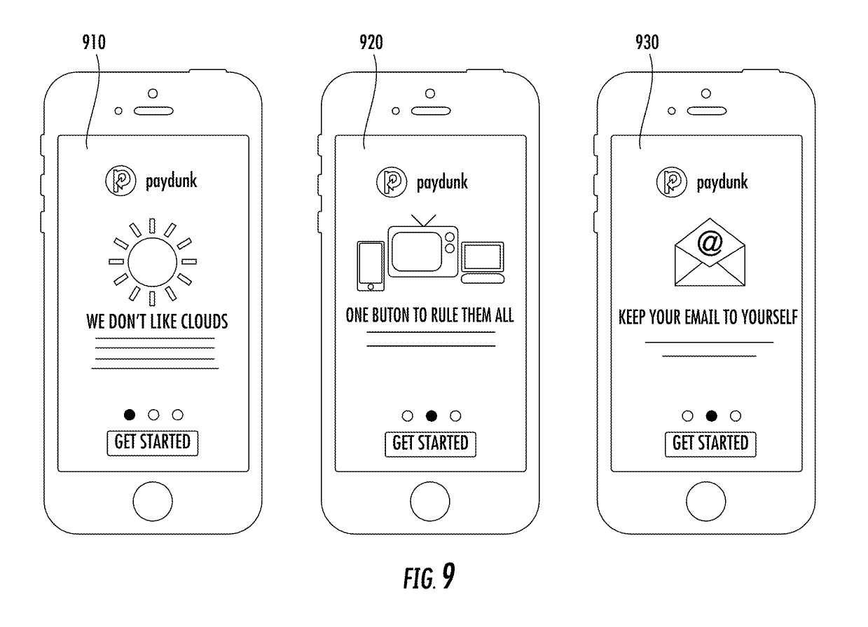

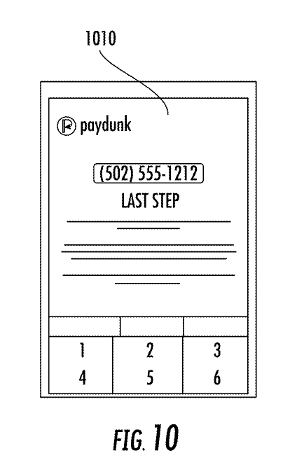

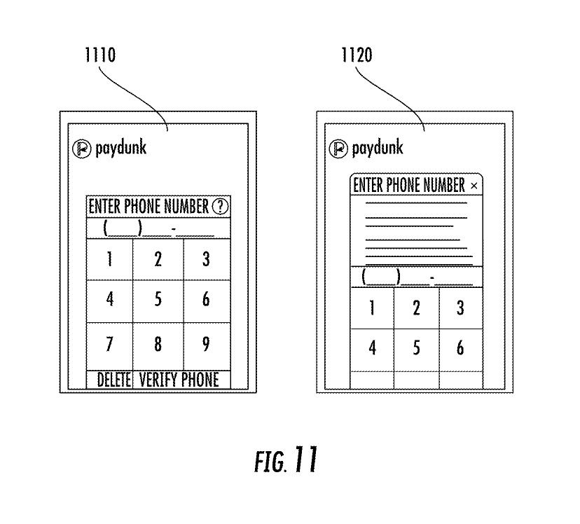

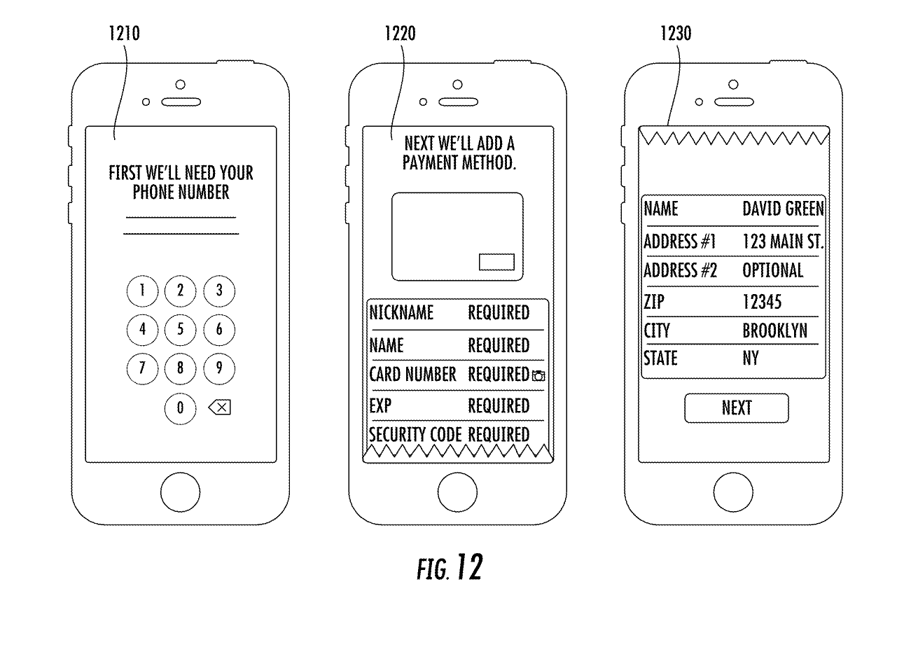

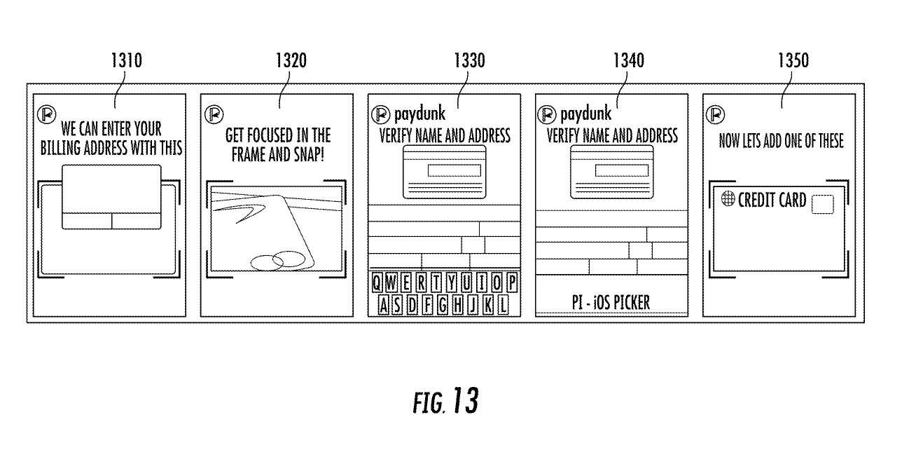

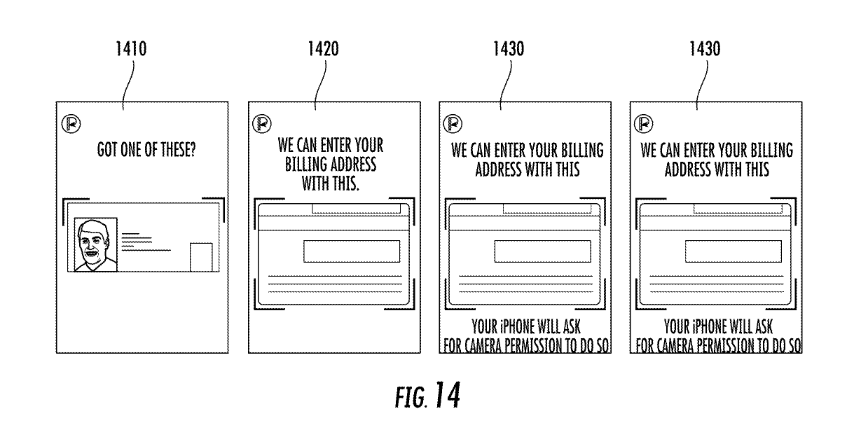

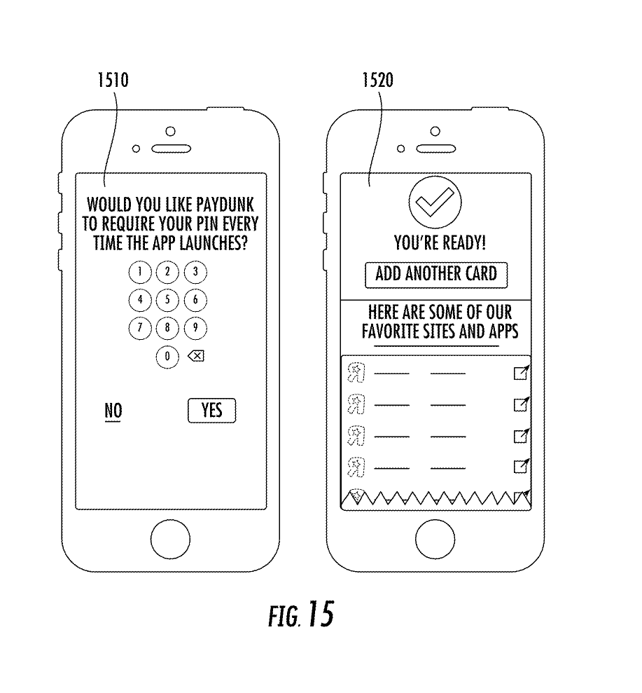

In step 338, if this is the first use of the application by the user, then the user can receive a tutorial about how it works. An exemplary user interface 910, 920, 930, as shown in FIG. 9, can explain the benefits of using the computer system, whereby selecting a “Get Started” button allows the user to create an account. In step 340, the user can add a billing address. In one alternative, a mobile device camera can capture an image of a drivers license or identification and scan a bar code on the drivers license to recognize an address for billing (and optionally shipping) information, as shown in an exemplary user interface 1410, 1420, 1430, 1440 in FIG. 14. In step 342, the user adds a credit card or other payment card account information. The user interface can present that “You will have the option to add more cards later.” The user can type in the payment card information as shown in an exemplary user interface 820, 830, 840, 850, 860, 1220 in FIGS. 8 and 12. The user may be required to have at least one valid payment method to use the application. As the user enters payment details, the user interface can automatically populate with card number, name, expiration date, and card type. Alternatively, a camera of the mobile device can be used to capture an image of the credit card and scan the image for payment card information, as shown in exemplary user interface 1230, 1310, 1320, 1330, 1340, 1350 in FIGS. 12 and 13. In step 344, the user enters a phone number. An exemplary user interface 1010, 1110, 1120, 1210 for entering a phone number is shown in FIGS. 10, 11, 12. In step 346, the user can select a PIN. In step 348, the user can confirm a PIN. As shown in an exemplary user interface 1510 in FIG. 15, an option is presented to require a PIN every time the application is opened or restored either by a pending transaction or directly by the user. In step 350, the user interface confirms that the user is ready and may recommend sites that allow for payments using this system. An exemplary user interface 1520 presents an option for adding another card and a list of retail partners is shown in FIG. 15. Optionally, the list of retail partners can be hard-coded into the application to provide a starting point after successful onboarding. In step 352, the user can add or edit payment card accounts.

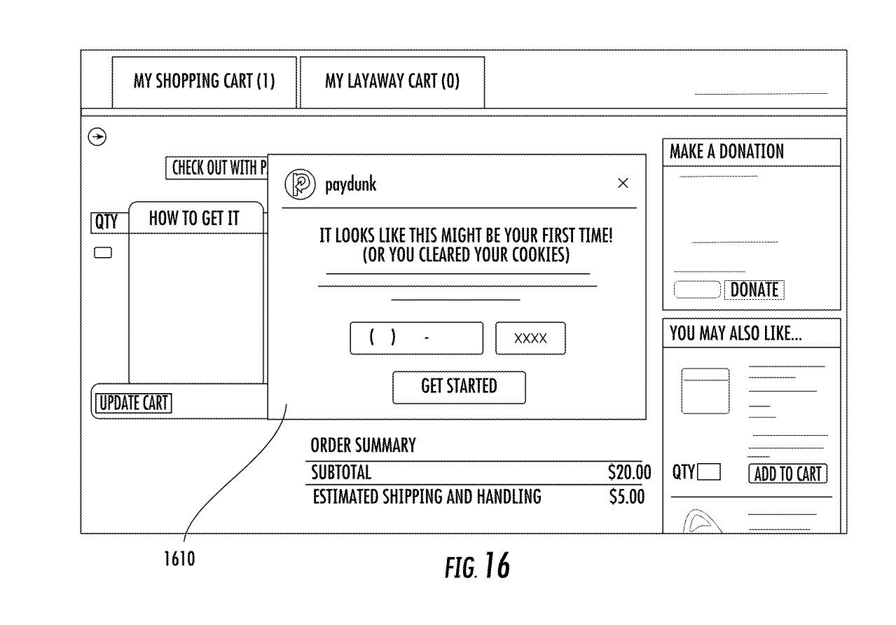

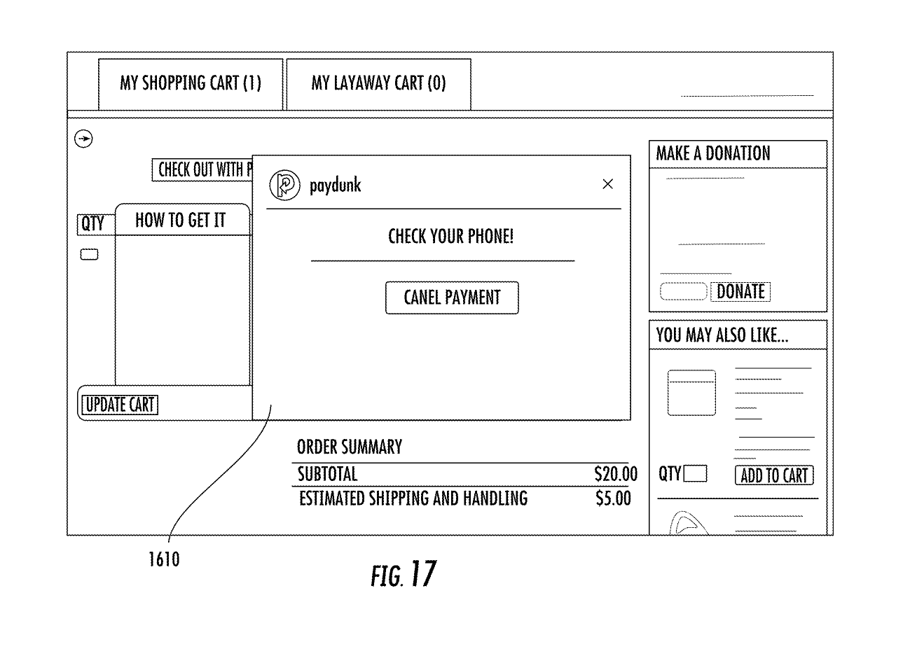

In step 354, a user activates a Paydunk button to pay for an item. In step 356, If the user is an existing user, it is determined whether the user is a new user. In step 360, it is determined if the user is a returning user. In step 360, if the user is not a returning user, the user enters a phone number and PIN. An exemplary web browser user interface 1610 is shown in FIG. 16, whereby the user interface 1610 presents a field to enter a phone number and a PIN to connect to the application, or the user can select a “Get Started” button to create an account. The user may receive a notice that the user will need to confirm payment within the application on the mobile device. An exemplary web browser user interface 1710 is shown in FIG. 17, whereby the user interface 1710 presents a notification to check the mobile device to confirm payment using the application to complete the purchase. In step 366, the payment is pending. In step 362, if the user is a new user, the user is prompted to enter a phone number. The user receives a notice that the user will receive an SMS message on the mobile device with a download link. In step 364, if the user is a returning user, the user enters a PIN. In step 366, the payment is pending. In step 368, the payment can be canceled.

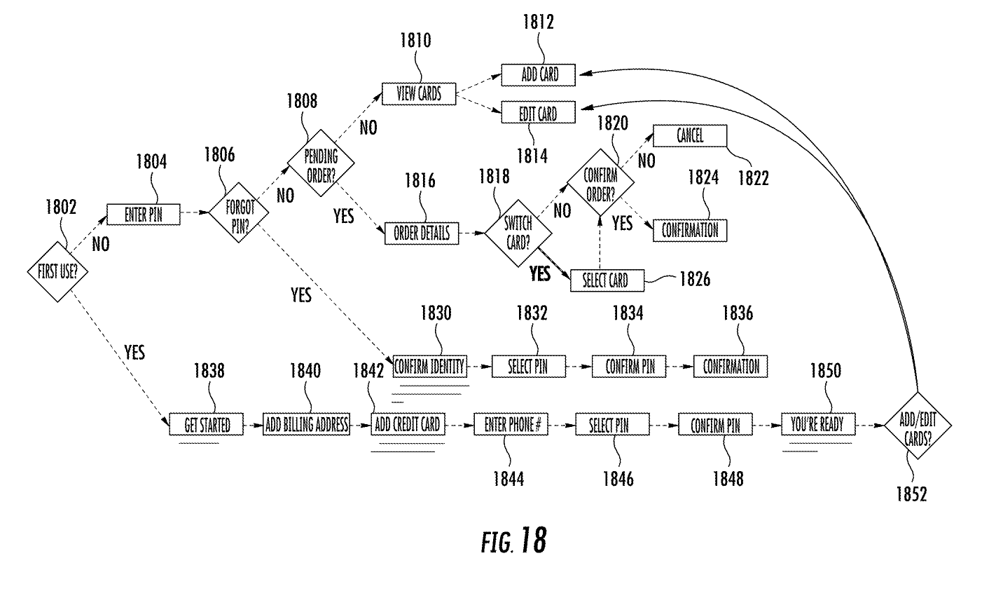

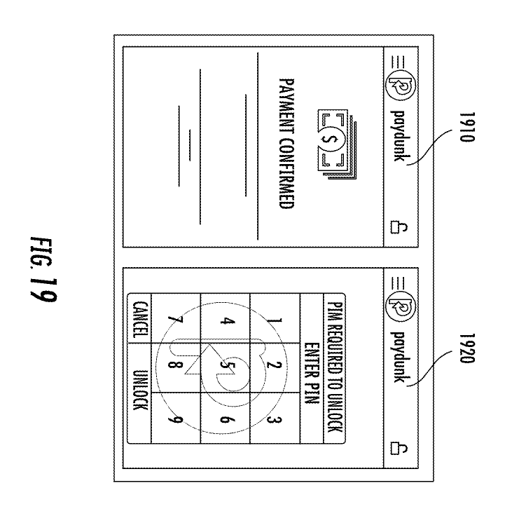

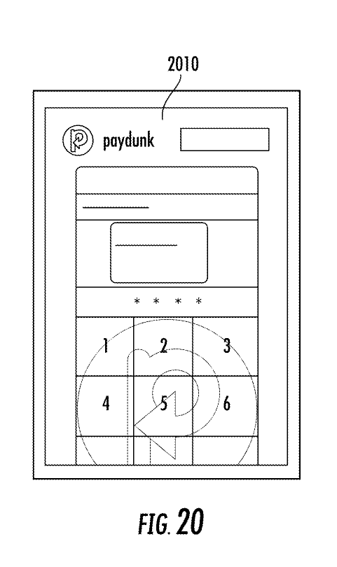

Referring to FIG. 18, a process for the application is shown. In step 1802, it is determined whether it is the user's first use of the application. In step 1804, if it not the first use, the user enters a PIN. An exemplary user interface 1920, 2010 for entering a PIN is shown in FIG. 19 and FIG. 20. In step 1806, it is determined whether the user forgot the PIN. In step 1808, if the user did not forget the PIN, it is determined whether there is a pending order. In step 1810, if there is no pending order, the user can view payment card accounts on the user interface. In step 1812, the user can add a payment card account. In step 1814, the user can edit a payment card account.

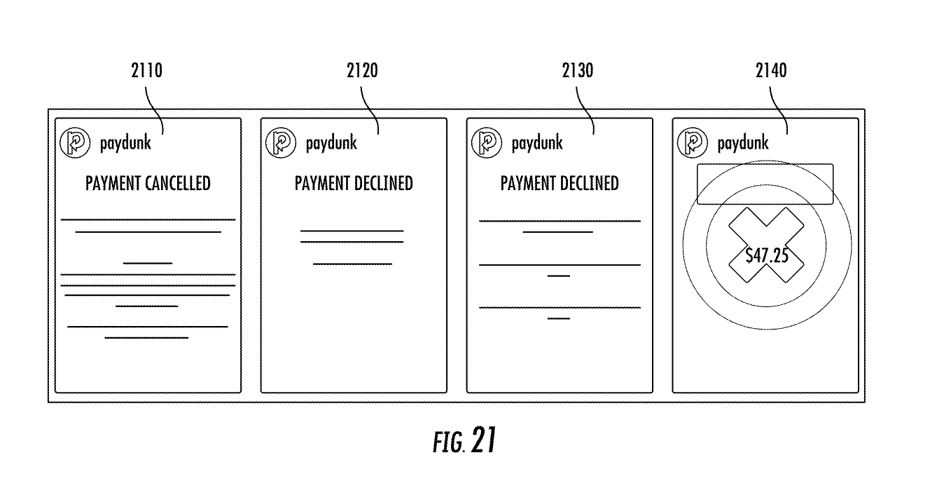

In step 1816, if there is a pending order, the order details are presented. In step 1818, it is determined whether to switch a payment card account. In step 1820, if not switching a payment card account, then it is determined whether to confirm the order. An exemplary user interface 420 for confirming a payment is shown in FIG. 4. The user interface 420 provides an option to confirm payment by tapping on the screen or decline the payment by selecting on a link. In step 1822, if not confirmed (e.g., the user selects the option to decline the payment), the order is canceled. An exemplary user interface 2110, 2120, 2130, 2140 for a canceled or declined payment is shown in FIG. 21. In step 1824, the order is confirmed. An exemplary user interface 1910 for a confirmed payment is shown in FIG. 19. In step 1826, if it is determined to switch a payment card account, a new payment card account is selected.

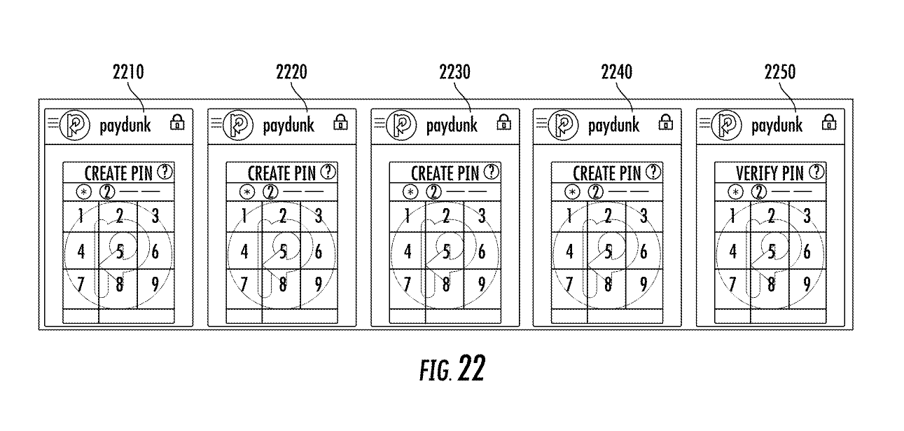

In step 1830, if the user forgot the PIN, the user confirms identity. The user may be asked to “Please enter the expiration date for the card ending in XXXX.” In step 1832, the user selects a new PIN. An exemplary user interface 2210, 2220, 2230, 2240 for creating a PIN is shown in FIG. 22. In step 1834, the user confirms the new PIN. An exemplary user interface 2250 for verifying a PIN is shown in FIG. 22. In step 1836, a confirmation is provided.

In step 1838, if the user is a first time user, the user is presented with a tutorial. In step 1840, the billing address is added. In step 1842, the user adds a payment card account. The user interface may present “You will have the option to add more cards later.” In step 1844, the user enters a phone number. An exemplary user interface 1010, 1110, 1120, 1210 for entering a phone number is shown in FIGS. 10, 11, 12. In step 1846, the user selects a PIN. In step 1848, the user confirms the PIN. In step 1850, the user interface confirms that the user is ready and may recommend sites that allow for payments using this system. In step 1852, the user can add or edit payment card accounts.

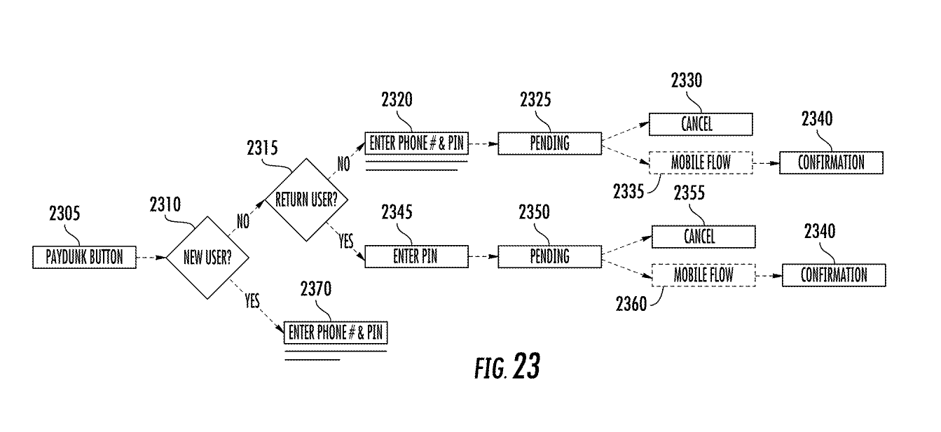

Referring to FIG. 23, a process for a partner site is shown. In step 2305, a Paydunk button is activated. In step 2310, it is determined whether the user is a new user. In step 2370, if the user is a new user, the user enters a phone number. The user interface can present a notice that the user will receive a SMS message with a download link.

In step 2315, it is determined if the user is a return user. In step 2320, if the user is not a return user, then the user enters a phone number and PIN in the user interface on the mobile device. The user interface can present a notice that the user will need to confirm payment within the application. In step 2325, the payment is pending. In step 2330, the payment can be canceled. In step 2335, the payment can be processed. In step 2340, the payment is confirmed.

In step 2345, if the user is a return user, the user enters a PIN. In step 2350, the payment is pending. In step 2355, the payment can be canceled. In step 2360, the payment can be processed. In step 2365, the payment is confirmed.

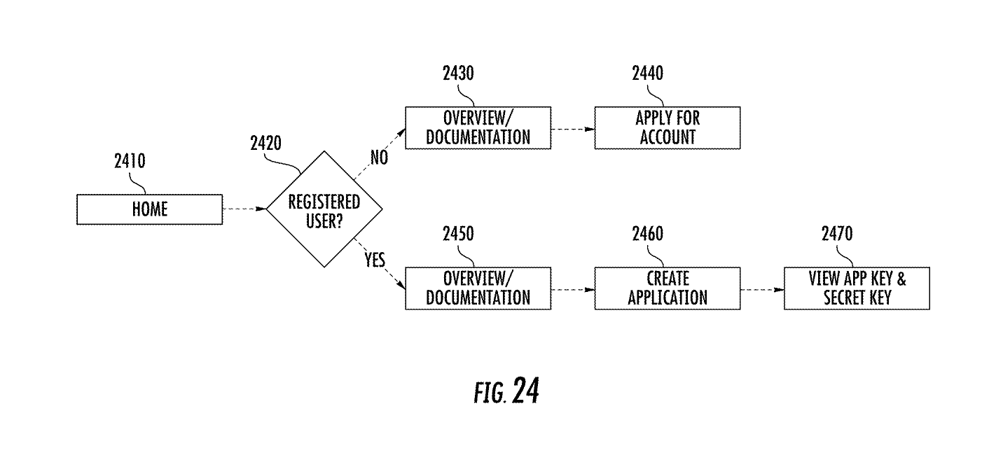

Referring to FIG. 24, a developer process is shown. In step 2410, the developer desires to add the computer system functionality described herein to an application or website by applying for API access. In step 2420, it is determined whether the developer is a registered user. In step 2430, if the developer is not a registered user, the user is provided with an overview and documentation. In step 2440, the developer can apply for an account. In step 2450, if the developer is a registered user, the developer is provided with an overview and documentation. In step 2460, an application is created. In step 2470, an application key and secret key are available to the developer.

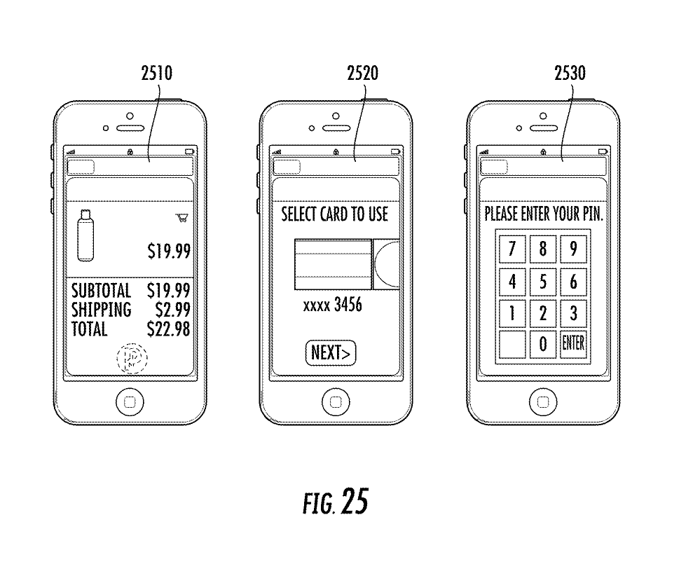

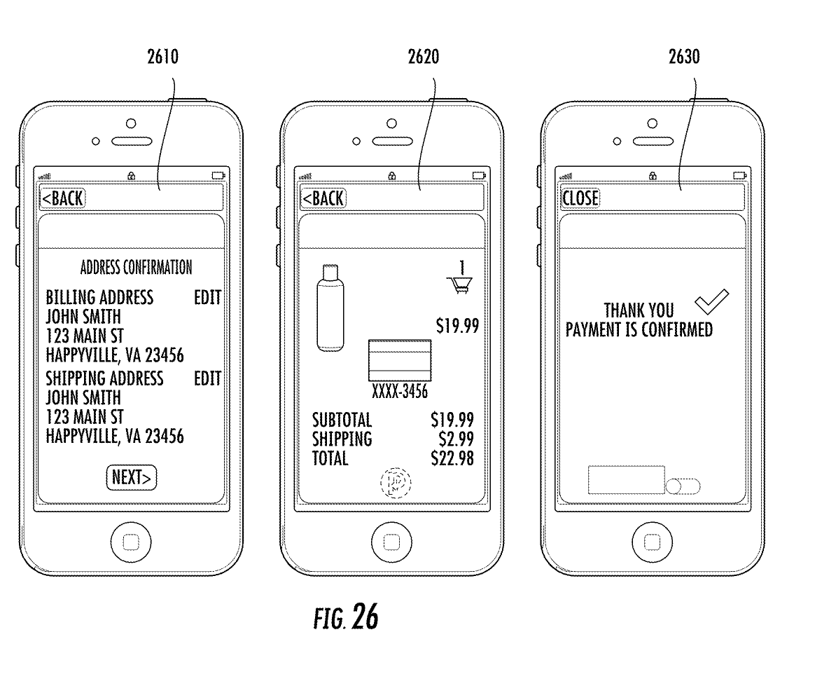

In an example of a use of the exemplary embodiment, a user can initiate a transaction to purchase an item on a website displayed on a web browser of a computing device, on a user interface of a television, or a browser or application on a mobile device. In one example, as shown in FIG. 25, a user interface 2510 on a mobile device shows a shampoo product for purchase on a Dermasolve website. The user can select to check out by activating a Paydunk link or button. A user interface 2520 on the mobile device allows for a selection of a payment card account (e.g., a Visa card) to pay for this product. Upon selection of the payment card account, a user interface 2530 allows the user to enter a pin on a numeric keypad that substantially extends to the perimeter of the user interface 2530. As shown in FIG. 26, if the correct PIN is entered, a user interface 2610 presents billing and shipping addresses for confirmation. A user interface 2620 presents a confirmation screen with the product, payment information, cost, and a button or link to make the payment. Upon selecting the button or link to make the payment, a user interface 2630 confirms that payment has been made.

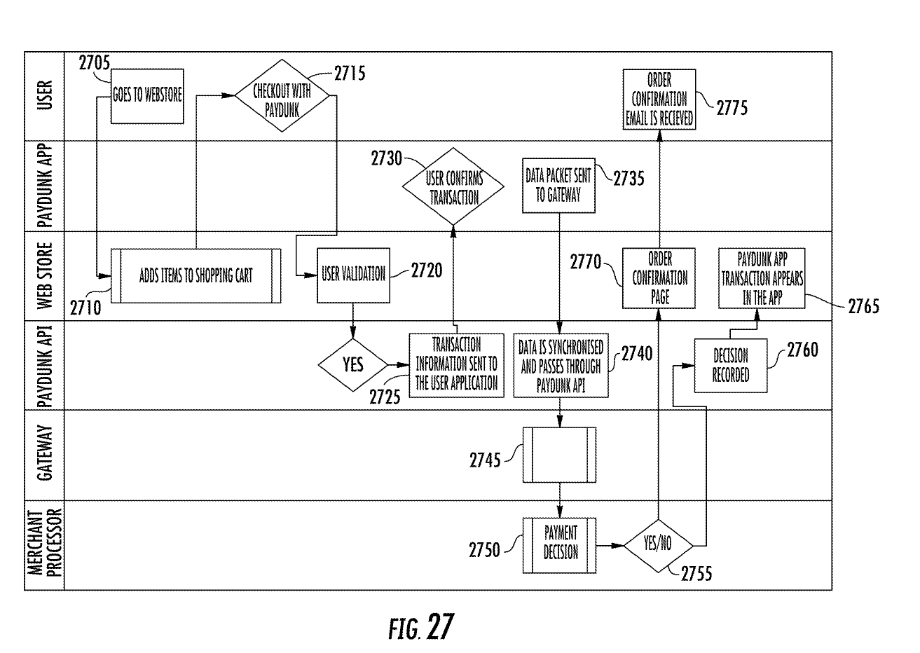

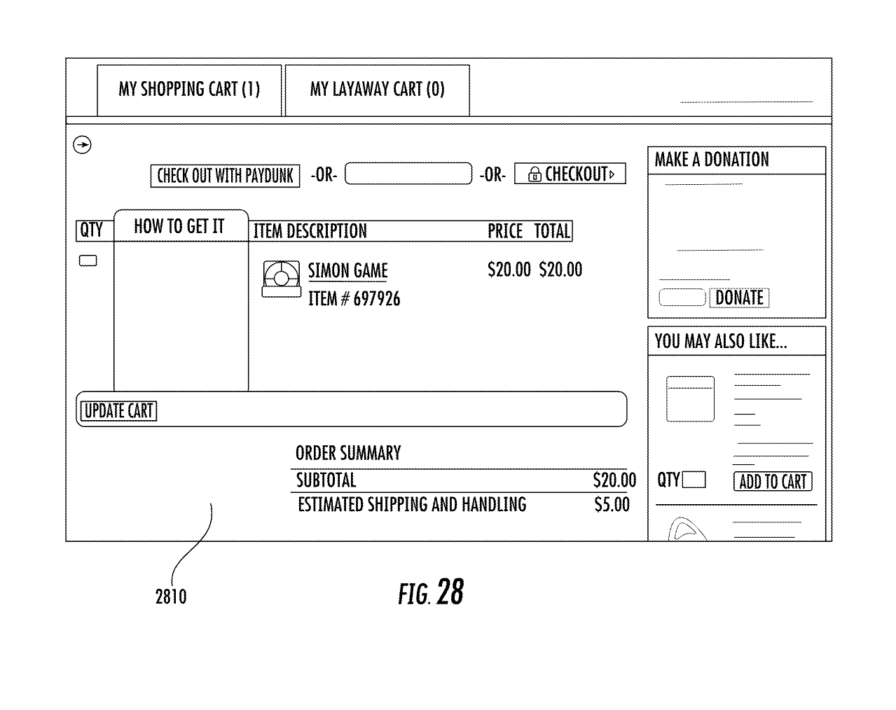

Referring to FIG. 27, a process for standardizing user information is shown. In step 2705, a user visits a webstore. In step 2710, a user adds items to a shopping cart on a user interface of the webstore to initiate a transaction. In step 2715, the user activates a Paydunk button on the user interface. An exemplary web browser user interface 2810 is shown in FIG. 28, whereby the user interface 2810 presents an option in a shopping cart to check out using Paydunk by selecting or activating a link in step 2715. In step 2720, the webstore can validate the user. In step 2725, transaction information is transmitted to an application on the mobile device of the user. In step 2730, the user confirms the transaction. In step 2735, a data packet is generated to be sent to the payment gateway processor. In step 2740, data is synchronized and passes through an API of the secure transaction server. In step 2745, the payment gateway processor decrypts the data packet. In step 2750, the merchant processor receives decrypted data from the payment gateway processor and makes payment decisions whether to approve or decline the transaction request. In step 2760, the payment decision is recorded by the secure transaction server API. In step 2765, the transaction appears in the application. In step 2770, the webstore displays an order confirmation page. In step 2775, the user receives an order confirmation email.

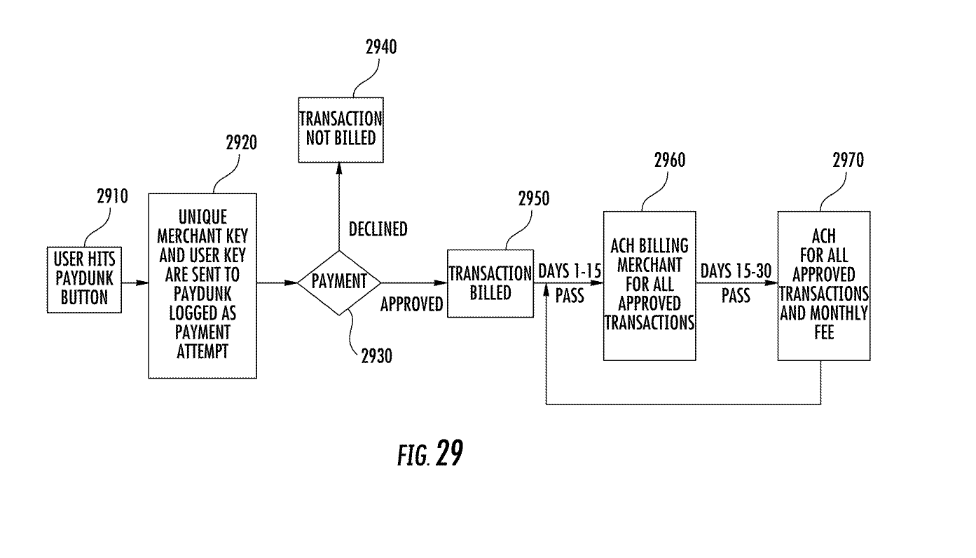

A merchant can be billed a monthly licensing fee for using the secure transaction server system. The fee can be based upon a volume of transactions, and a transaction log is maintained to calculate the volume of transactions in a predetermined time period. In one exemplary embodiment, referring to FIG. 29, a process for billing for each transaction is shown. In step 2910, a user activates a button or link on a user interface. In step 2920, a unique merchant key and user key are sent to the secure transaction server, which logs the payment attempt. A transaction billing log can include date, time, user key, merchant key, internet protocol (IP) address of user, and a merchant transaction identification number (merchant ID). In step 2930, the secure transaction server determines whether the user has declined or approved the payment using the application on the mobile pone. In step 2940, if payment has been declined, then the transaction is not billed. In step 2950, if payment has been approved, then the transaction is billed. Within days 1-15, the process proceeds to step 2960. In step 2960, the merchant is billed via Automated Clearing House (ACH) for all approved transactions. Within days 15-30 from the transaction being billed, the process proceeds to step 2970. In step 2970, all approved transactions and monthly fees are processed via ACH.

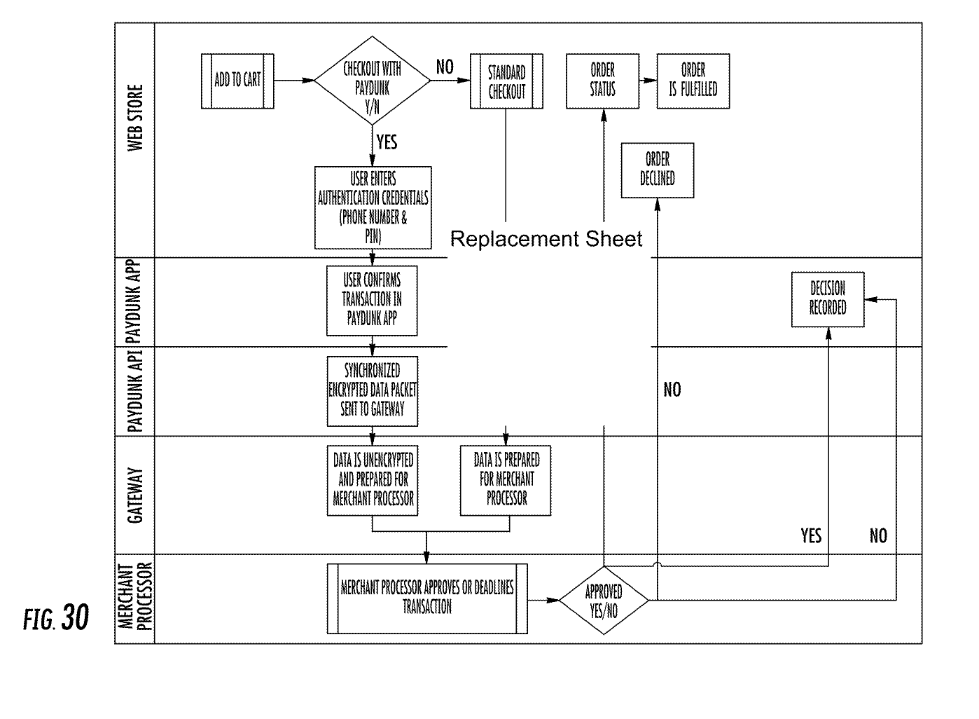

Referring to FIG. 30, an exemplary process is shown. A user adds an item to a shopping cart for purchase on a website of a webstore. The user can activate a link to check out using Paydunk. If the user decides not to use Paydunk, the user can proceed to a standard checkout process. Data is then prepared by the payment gateway processor for the merchant processor, and the merchant processor approves or declines the transaction.

If the user activates the link to check out using Paydunk, then the user is prompted to enter authentication credentials (e.g., phone number and PIN). The user confirms the transaction using the application on the mobile device of the user. The application sends a synchronized encrypted data packet via the secure transaction server API to the payment gateway processor, which unencrypts the data packet and prepares it for the merchant processor. The merchant processor can approve or decline the transaction, and the decision is recorded by the Paydunk application on the mobile device of the user. If the merchant processor approves the transaction, the order status is updated at the webstore upon receiving notification transmitted from the merchant processor, and then the webstore fulfills the order. If the merchant declines the transaction, the order status is updated at the webstore upon receiving notification transmitted from the merchant processor.

In one embodiment, a system comprises a data store containing data, for each of a plurality of mobile devices, each mobile device having an association with phone number data, personal identification number data, billing address data, payment card number data, and expiration date data; and a secure transaction server communicatively coupled to the data store and programmed to: receive from a merchant server over a network a signal including activation of a link displayed on an electronic web page hosted by the merchant server; receive over the network a signal including phone number data and personal identification number data from the electronic web page; transmit a message requesting confirmation of a transaction to a phone number of a mobile device in the received phone number data when a personal identification number in the received personal identification number data is authenticated upon a comparison with the data in the data store, wherein the message comprises transaction information, and whereby the message causes a restoration of an application on the mobile device; receive from the application on the mobile device associated with the phone number an encrypted packet comprising the transaction information and payment information upon a receipt of an authorization command by the application for the transaction; and transmit the encrypted packet to a payment gateway server, whereby the payment gateway server decrypts the packet and transmits the transaction information and payment information to a merchant processor, and wherein the merchant server does not receive payment card number data for the transaction.

In another embodiment, a computer-implemented method comprises receiving, by a secure transaction server, from a merchant server over a network a signal including activation of a link displayed on an electronic web page hosted by the merchant server; receiving, by the secure transaction server, over the network a signal including phone number data and personal identification number data from the electronic web page; transmitting, by the secure transaction server, a message requesting confirmation of a transaction to a phone number of a mobile device in the received phone number data when a personal identification number in the received personal identification number data is authenticated upon a comparison with the data in the data store, wherein the message comprises transaction information, and whereby the message causes a restoration of an application on the mobile device; receiving, by the secure transaction server, from the application on the mobile device associated with the phone number an encrypted packet comprising the transaction information and payment information upon a receipt of an authorization command by the application for the transaction; and transmitting, by the secure transaction server, the encrypted packet to a payment gateway server, whereby the payment gateway server decrypts the packet and transmits the transaction information and payment information to a merchant processor, and wherein the merchant server does not receive payment card number data for the transaction.

In yet another embodiment, a computer-implemented method comprises receiving, by a secure transaction server, a phone number and a personal identification number entered on a modal of a webpage hosted by a merchant server; confirming, by the secure transaction server, a user using the received phone number and personal identification number; generate, by the secure transaction server, transaction information for display on an application of a mobile device; causing, by the secure transaction server, a restoration of the application of the mobile device to display the transaction information; receiving, by the secure transaction server, a packet of encrypted information generated by the application and comprising the transaction information and payment information; and transmitting, by the secure transaction server, the packet of encrypted information to a payment gateway server that is configured to decrypt the encrypted information and transmit the decrypted information to a merchant processor for processing, wherein the merchant server does not receive the payment information.

The systems and methods offer include various security features. In one embodiment, two factor authentication is required for payment. The two security parameters can include the mobile device (e.g., mobile phone) and at least one of a personal identification number (PIN), card scan, or biometric authentication (e.g., iris scan, fingerprint scan, facial recognition).

The computer system described herein can be configured for recurring bill payments. Websites can be configured to accept payments, as described above, for rendered services and products. The secure transaction server can instruct a payment to be withdrawn from a user's account (e.g., checking account). The user can configure a plurality of payment card accounts (e.g., credit card, debit card) and bank accounts for paying bills. The user can interact with the user interface to configure which bills to pay, an amount, date, time, frequency, and source of funds. The system can transmit a push notification about an upcoming bill (e.g., up to 15 prior to the pre-configured payment release date). The date of the reminder can be configured to be unique for each payment. Each push notification can include an option to “Pay Now!” or “Remind me again in [time period].” If the user selects the reminder option, the computer system will allow the user to then select a number of days to trigger another push notification. If the bill date arrives after the reminders have been pushed to the mobile device and no selection has been received, the system can be configured with various options: (1) release payment on the date of the required bill payment as previously configured even if the “Pay Now!” option has not been selected; and (2) withhold payment even if the payment date is reached unless the user transmits instructions to release the payment. The user can opt out of the reminder option and configure the computer system to pay bills at designated dates and/or times. At the time of release of a payment, the system can send a push notification to the mobile device of the user.

The computer system described herein can be configured to eliminate a user's password and use a push notification from the secure transaction server as a method of authentication. Instead of having to remember multiple passwords for many different sites, the user only needs to remember their own phone number and their PIN. A website can use the system described herein as a method of authentication and offer a link to “Login with Paydunk.” The user can input credentials (e.g., phone number and PIN) in fields on the website interface. The secure transaction server will transmit a push notification to the user's mobile device asking to accept or deny the authentication request. If the user accepts the authentication request by sending a responsive text message or accessing an application to confirm authentication, then the secure transaction server will transmit an authentication approval message to the server of the website so that the user can be automatically logged in and confirm to the user that authentication is successful. If the user declines authentication by sending a responsive text message or accessing an application to decline authentication, the secure transaction server will transmit a message to the server of the website to display a message stating that the authentication request has been declined.

A website can present fields for a user to log in using a username and password, which is validated with a username and password stored in a database at the host, and can additionally present a link to “Login with Paydunk.” If the user chooses to activate the link, the user is prompted with fields on a user interface to enter a phone number and PIN. Upon receipt of the phone number and confirmation that the PIN is associated with that phone number, the secure transaction server will send a push notification to the user's mobile device using the transmitted phone number and asking to accept or deny the authentication request. If the user accepts the authentication request by sending a responsive text message or accessing an application to confirm authentication, then the secure transaction server will transmit an authentication approval message to the server of the website so that the user can be automatically logged in and confirm to the user that authentication is successful. If the user declines authentication by sending a responsive text message or accessing an application to decline authentication, the secure transaction server will transmit a message to the server of the website to display a message stating that the authentication request has been declined.

An exemplary process follows. First, a user browses to a website requiring authentication. Second, the user activates a link labeled “Login with Paydunk.” Third, the website will be instructed to launch a dialog box requesting that the user enter their phone number. Fourth, upon receiving the inputted phone number, the dialog box will ask the user for the PIN. Fifth, the user will activate a link labeled “Submit.” Sixth, the secure transaction server will verify that the entered phone number and PIN correlate to an account. Seventh, once the secure transaction server has completed verification, the secure transaction server will transmit a push notification to the user's mobile device and ask if they want to “Accept” or “Decline” the authentication request. Eighth, if the user chooses to accept, the secure transaction server will forward that request to the website host to automatically log in the user and display a message stating “Authentication Successful.” If the user chooses to decline, the secure transaction server will forward that request to the website host and display a message stating “Authentication Declined.”

The functionality described herein can be implemented by numerous modules or components that can perform one or multiple functions. Each module or component can be executed by a computer, such as a server, having a non-transitory computer-readable medium and processor. In one alternative, multiple computers may be necessary to implement the functionality of one module or component.

Unless specifically stated otherwise as apparent from the following discussion, it is appreciated that throughout the description, discussions utilizing terms such as “processing” or “computing” or “calculating” or “determining” or “measuring” or “selecting” or “displaying” or “identifying” or “detecting” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The exemplary embodiments can relate to an apparatus for performing one or more of the functions described herein. This apparatus may be specially constructed for the required purposes, or it may comprise a specially programmed computer selectively activated or reconfigured by a computer program stored in the computer. Such a computer program may be stored in a machine (e.g. computer) readable storage medium, such as, but is not limited to, any type of disk including floppy disks, optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions, and each coupled to a bus.

The exemplary embodiments described herein are described as software executed on at least one server, though it is understood that embodiments can be configured in other ways and retain functionality. The embodiments can be implemented on known devices such as a personal computer, a special purpose computer, cellular telephone, personal digital assistant (“PDA”), a digital camera, a digital tablet, an electronic gaming system, a programmed microprocessor or microcontroller and peripheral integrated circuit element(s), and ASIC or other integrated circuit, a digital signal processor, a hard-wired electronic or logic circuit such as a discrete element circuit, a programmable logic device such as a PLD, PLA, FPGA, PAL, or the like. In general, any device capable of implementing the processes described herein can be used to implement the systems and techniques according to this invention.

It is to be appreciated that the various components of the technology can be located at distant portions of a distributed network and/or the Internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

The embodiments described above are intended to be exemplary. One skilled in the art recognizes that there are numerous alternative components and embodiments that may be substituted for or included in the particular examples described herein and such additions or substitutions still fall within the scope of the invention.

What is claimed is:

1. A system comprising:
a data store containing data, for each of a plurality of mobile devices, each mobile device having an association with phone number data, personal identification number data, billing address data, payment card number data, and expiration date data; and
a secure transaction server communicatively coupled to the data store and programmed to:
receive from a merchant server over a network a signal including activation of a link displayed on an electronic web page hosted by the merchant server;
receive over the network a signal including phone number data and personal identification number data from the electronic web page;
transmit a message requesting confirmation of a transaction to a phone number of a mobile device in the received phone number data when a personal identification number in the received personal identification number data is authenticated upon a comparison with the data in the data store,
wherein the message comprises transaction information, and
whereby the message causes a restoration of an application on the mobile device;
receive from the application on the mobile device associated with the phone number an encrypted packet comprising the transaction information and payment information upon a receipt of an authorization command by the application for the transaction; and
transmit the encrypted packet to a payment gateway server,
whereby the payment gateway server decrypts the packet and transmits the transaction information and payment information to a merchant processor, and
wherein the merchant server does not receive payment card number data for the transaction.

2. The system according to claim 1, wherein the secure transaction server receives an input of a personal identification number from the application on the mobile device when receiving the signal to authorize the transaction.

3. The system according to claim 1, wherein the transaction information comprises a transaction amount and an identification of at least one item to be purchased.

4. The system according to claim 1, wherein the authorization command on the mobile device comprises an input of the personal identification number and validation of the inputted personal identification number.

5. The system according to claim 1, wherein the secure transaction processor further comprises an application program interface configured to interface with the application on the mobile device.

6. The system according to claim 1, wherein the payment information comprises a payment card account number and an expiration date.

7. The system according to claim 1, whereby the merchant processor transmits a payment confirmation to the merchant server.

8. The system according to claim 1, whereby the merchant processor transmits a name, billing information, and shipping information to the merchant server.

9. A computer-implemented method comprising:
receiving, by a secure transaction server, from a merchant server over a network a signal including activation of a link displayed on an electronic web page hosted by the merchant server;
receiving, by the secure transaction server, over the network a signal including phone number data and personal identification number data from the electronic web page;
transmitting, by the secure transaction server, a message requesting confirmation of a transaction to a phone number of a mobile device in the received phone number data when a personal identification number in the received personal identification number data is authenticated upon a comparison with the data in the data store,
wherein the message comprises transaction information, and
whereby the message causes a restoration of an application on the mobile device;
receiving, by the secure transaction server, from the application on the mobile device associated with the phone number an encrypted packet comprising the transaction information and payment information upon a receipt of an authorization command by the application for the transaction; and
transmitting, by the secure transaction server, the encrypted packet to a payment gateway server,
whereby the payment gateway server decrypts the packet and transmits the transaction information and payment information to a merchant processor, and
wherein the merchant server does not receive payment card number data for the transaction.

10. The method according to claim 9, wherein the secure transaction server receives an input of a personal identification number from the application on the mobile device when receiving the signal to authorize the transaction.

11. The method according to claim 9, wherein the transaction information comprises a transaction amount and an identification of at least one item to be purchased.

12. The method according to claim 9, wherein the authorization command on the mobile device comprises an input of the personal identification number and validation of the inputted personal identification number.

13. The method according to claim 9, wherein the secure transaction processor further comprises an application program interface configured to interface with the application on the mobile device.

14. The method according to claim 9, wherein the payment information comprises a payment card account number and an expiration date.

15. The method according to claim 9, whereby the merchant processor transmits a payment confirmation to the merchant server.

16. The method according to claim 9, whereby the merchant processor transmits a name, billing information, and shipping information to the merchant server.

17. A computer-implemented method comprising:
receiving, by a secure transaction server, a phone number and a personal identification number entered on a modal of a webpage hosted by a merchant server;
confirming, by the secure transaction server, a user using the received phone number and personal identification number;
generate, by the secure transaction server, transaction information for display on an application of a mobile device;
causing, by the secure transaction server, a restoration of the application of the mobile device to display the transaction information;
receiving, by the secure transaction server, a packet of encrypted information generated by the application and comprising the transaction information and payment information; and
transmitting, by the secure transaction server, the packet of encrypted information to a payment gateway server that is configured to decrypt the encrypted information and transmit the decrypted information to a merchant processor for processing,
wherein the merchant server does not receive the payment information.

18. The method according to claim 17, wherein the authorization command on the mobile device comprises an input of the personal identification number and validation of the inputted personal identification number.

19. The method according to claim 17, whereby the merchant processor transmits a payment confirmation to the merchant server.

20. The method according to claim 17, whereby the merchant processor transmits a name, billing information, and shipping information to the merchant server.
